(19) United States
(12) Patent Application Publication
(10) Pub. No.: US 2019/0178262 A1
(43) Pub. Date: Jun. 13, 2019

(54) Flow Machine And Method For The Production Thereof

(71) Applicant: MAN ENERGY SOLUTIONS SE, Augsburg (DE)

(72) Inventors: Richard BÜSSOW, Berlin (DE); Robert KLAWES, Neuendorf (DE)

(21) Appl. No.: 16/319,116

(22) PCT Filed: Jan. 31, 2017
(86) PCT No.: PCT/EP2017/051976

§ 371 Date: Jan. 18, 2019

(30) Foreign Application Priority Data
Jul. 20, 2016 (DE) 10 2016 213 296.2

(51) Int. Cl. F04D 29/66; F02C 6/12

(52) U.S. Cl. CPC F04D 29/66; F02C 6/12; F05B 2230/22; F05B 2280/6012; F05B 2240/10; F05B 2260/964; F05B 2230/21

(57) ABSTRACT

The invention relates to a flow machine (10), in particular a radial compressor, comprising a rotor (11) with a rotor blade (12); a stator (13) with, preferably, a guide vane (17), the stator defining at least in sections, the at least one flow channel (14) leading to the rotor blades (12) of the rotor (11) and a flow channel (15) leading away from the rotor blades (12) of the rotor (11); the stator (13) comprising, in the region of at least one flow channel (14, 15) at least one foam-like porous sound damping element (23).

### CROSS REFERENCE TO RELATED APPLICATIONS

This is a U.S. national stage of application No. PCT/EP2017/051976, filed on Jan. 31, 2017. Priority is claimed on German Application No. DE102016213296.2, filed Jul. 20, 2016, the content of which is incorporated herein by reference.

### BACKGROUND OF THE INVENTION

### 1. Field of the Invention

The invention relates to a turbomachine, in particular to a radial turbomachine, and to a method for producing the same.

### 2. Description of the Prior Art

From U.S. Pat. No. 6,669,436 B2 a turbomachine, namely a radial compressor, having a rotor comprising moving blades and a stator comprising guide blades is known. Seen in the flow direction of the medium to be compressed, the guide blades of the stator are designed as guide blades of a diffuser arranged downstream of the moving blades of the rotor. Accordingly, the guide blades are positioned in the region of a flow passage, which leads away from the moving blades of the rotor. From U.S. Pat. No. 6,669,436 B2 it is known, furthermore, to provide a sound-damping element in the region of the diffuser, namely in the region of the guide blades of the diffuser. Here, this sound-damping element is an integral part of a diffuser ring designed as a plate-like ring with multiple apertures, wherein the apertures lead to hollow spaces. The sound-damping element known from U.S. Pat. No. 6,669,436 B2, which is an integral part of a diffuser ring, acts as a resonator which comprises hollow spaces which, via apertures, are in connection with the flow passage in the region of the diffuser. The damping effect of such a sound-damping element is limited.

### SUMMARY OF THE INVENTION

Starting out from this, one aspect of the present invention is a new type of turbomachine and a method for producing the same.

According to one aspect of the invention, the stator, in the region of at least one flow passage, comprises at least one foam-like porous sound-damping element. Such a sound-damping element has good sound-damping characteristics while the same, furthermore, can be produced simply and cost-effectively.

According to an advantageous further development, the respective foam-like sound-damping element is designed as a metal foam element, which is preferentially produced by way of a generative manufacturing method and individually formed as sintered metal foam-like element. A metal foam element as sound-damping element produced by way of a generative manufacturing method is particularly preferred.

Preferentially, the porosity of the respective foam-like sound-damping element is not equally distributed but locally different in terms of the number of pores and/or pore depth. The variation of the porosity is not solely dependent on the pore size but also on the material density with constant pore size. The variation of the pore size and pore shape also influences the porosity. By way of the different distribution of the porosity of the respective sound-damping element, the sound-damping characteristics and strength properties can be optimally adjusted.

According to an advantageous further development, the respective foam-like sound-damping element is an integral part of a diffuser comprising guide blades. Preferentially, the guide blades have a flow leading edge, a flow trailing edge and flow control surfaces extending between these edges, wherein in a middle region between the flow leading edge and the flow trailing edge a larger number of pores is and/or are formed than in the regions adjoining the flow leading edge and the flow trailing edge, and/or wherein in a middle region between the flow control surfaces of adjacent guide blades a larger number of pores and/or deeper pores is and/or are formed than in the regions adjoining the respective flow control surface. By way of this, the sound damping characteristics can be optimally adjusted in the region of the diffuser.

According to an advantageous further development of the invention, walls, delimiting the respective flow passage and/or guide blades positioned in the respective flow passage are embodied as flow-like, porous sound-damping element at least in sections. This allows an optimal adjustment of sound-damping characteristics in the region of a stator-side flow passage of a turbomachine.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1 is an axial section through a turbomachine designed as radial compressor;

FIG. 2 is a view in the direction II of FIG. 1 of a diffuser of the radial compressor of FIG. 1;

FIG. 3 is a view in the direction II of FIG. 1 of an alternative diffuser of the radial compressor of FIG. 1;

FIG. 4 is a view in the direction II of FIG. 1 of a further alternative diffuser of the radial compressor of FIG. 1; and

FIG. 5 is an axial section through a further turbomachine designed as radial compressor.

### DETAILED DESCRIPTION OF THE PRESENTLY PREFERRED EMBODIMENTS

The invention relates to a turbomachine, in particular to a radial turbomachine. The invention, furthermore, relates to a method for producing such a turbomachine.

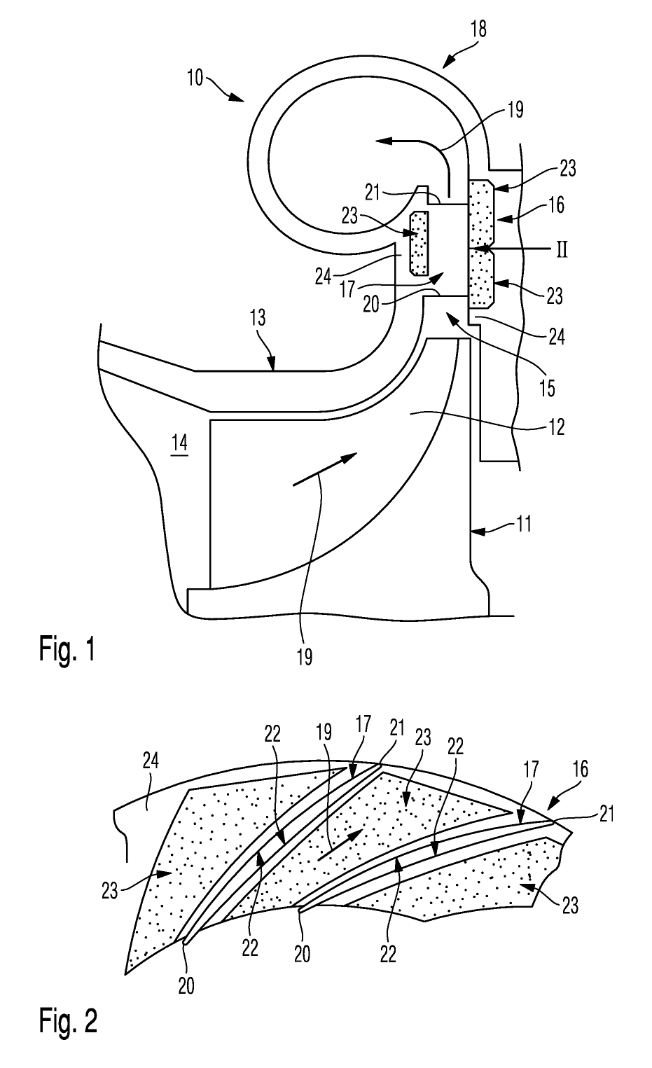

FIGS. 1 and 2 show different views of a turbomachine 10 designed as radial compressor.

The turbomachine 10 of FIGS. 1 and 2 formed as radial compressor comprises a rotor 11 with moving blades 12. Furthermore, the turbomachine 10 designed as radial compressor comprises a stator 13, wherein the stator 13 on the one hand delimits a flow passage 14 leading to the moving blades 12 of the rotor 11 extending in the axial direction on the other hand a flow passage 15 leading away from the moving blades 12 of the rotor 11 and extending in the radial direction, at least in sections.

A diffuser 16 comprising guide blades 17 is part of the stator 13. Seen in the flow direction of the medium to be compressed, the guide blades 17 of the diffuser 16 are positioned downstream of the moving blades 12 of the rotor 11 in the flow passage 15 extending in the radial direction. A spiral-shaped outflow housing 18 of the stator 13 follows downstream of the diffuser 16. The flow direction of the medium to be compressed is visualised by arrows 19 in FIG. 1.

FIG. 2 shows a view II of the diffuser 16, namely of the guide blades 17 of the diffuser 16 and of a wall 24 of the same. Each of the guide blades 17 comprises a flow leading edge 20, a flow trailing edge 21 and flow control surfaces 22 extending between the respective flow leading edge 20 and the flow trailing edge 21. In the case of the turbomachine according to the invention, the stator 13 comprises a foam-like, porous sound-damping element 23 in the region of at least one flow passage 14 and/or 15.

The respective foam-like, porous sound-damping element 23 can be formed as a metal foam element, in particular as a sintered metal-like element, or as a plastic foam element. In the case of a metal foam element, the same is preferentially produced by way of a generative manufacturing method.

In the exemplary embodiment of FIGS. 1 and 2, in which the stator 13, in the region of the diffuser 16, comprises the or each foam-like, porous sound-damping element 23 it is provided that walls 24 of the stator 13, which in sections delimit the flow passage 15 leading away from the guide blades 12 of the rotor 11 at least in sections are embodied as foam-like, porous sound-damping element 23 at least in sections, namely preferentially on both axial sides or only on one axial side of the flow passage 15 of the stator 13 extending in the radial direction and leading away from the moving blades 12 of the rotor 11 in the region of the diffuser 16. This allows a particularly effective sound-damping. Pressure shocks emanating from the rotor 11 and acting on the diffuser 16 can be directly dampened at the source.

In the exemplary embodiment shown in FIGS. 1 and 2, the porosity of the respective foam-like sound-damping element is equally distributed, i.e. the foam-like sound-damping element 23 has an equal distribution in term of number, depths, and size of the pores.

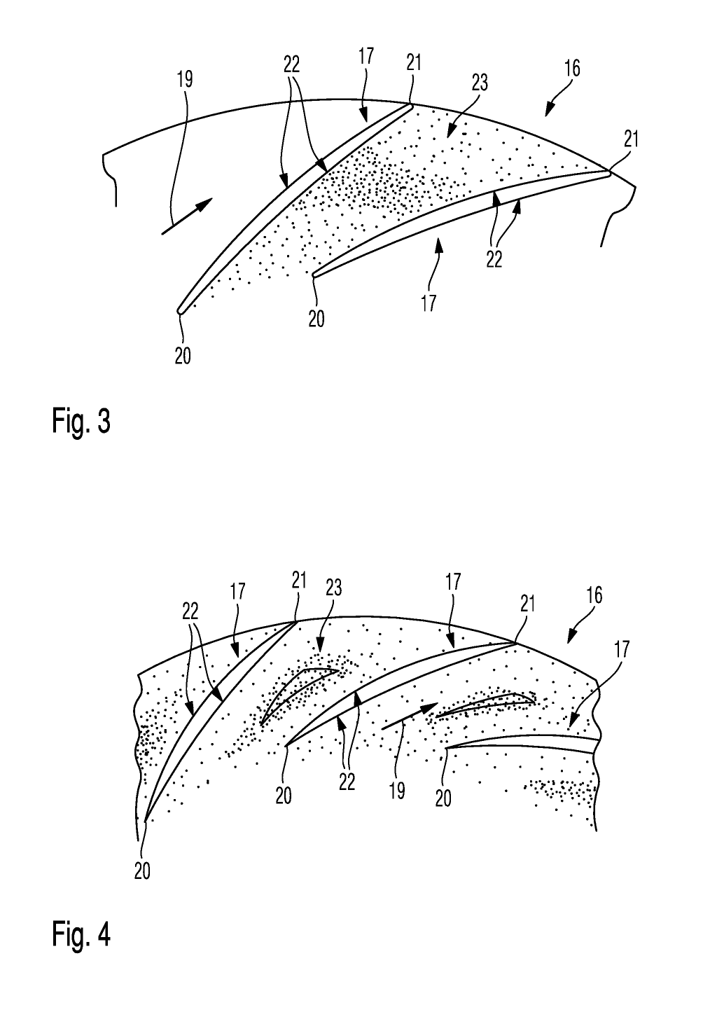

Compared with this, FIGS. 3 and 4 show versions of the invention in the case of which the respective foam-like sound-damping element 23 in terms of number of pores and pore depth does not have an equally distributed porosity but rather a locally distinct porosity. Accordingly, the walls 24 extending in the radial direction in FIGS. 3 and 4, which in sections delimit the flow passage 15 extending in the radial direction in the region of the diffuser 16, are embodied in sections as foam-like porous sound-damping element 23.

In FIG. 3, a larger number of pores and a greater depth of the pores is provided or formed in a middle region between the flow leading edge 20 and the flow trailing edge 21 than in regions that are directly adjoining the flow leading edge 20 and the flow trailing edge 21.

In FIG. 4, the porosity of the walls 24 of the rotor 13 delimiting the flow passage 15 extending in the radial direction is additionally locally distinct in the region of the diffuser 16 in such a manner that in a middle region between the flow control surfaces 22 of adjacent guide blades 17 of the diffuser 16 a larger number of pores and deeper pores is or are formed than directly adjacent to the respective flow-controlling surface 23 of the respective guide blade 17.

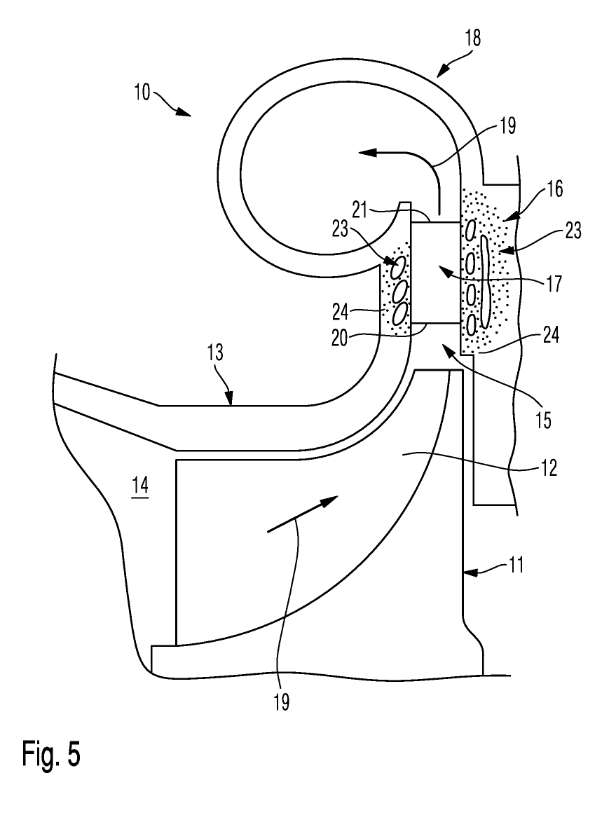

FIG. 5 shows the walls 24 of the stator 13 delimiting the flow passage 15 extending in the radial direction in the region of the diffuser 16 have a locally distinct porosity seen over their axial thickness. Accordingly it is provided in FIG. 5 that in an axially middle region of these walls 24, larger pores are formed than directly adjacent to the flow passage 15.

Although it is preferred that walls 24 delimiting the respective flow passage 14, 15 are at least in sections embodied as foam-like porous sound-damping elements 13, it is alternatively or additionally also possible that guide blades 17 positioned in the respective flow passage 14, 15 are embodied as foam-like porous sound-damping elements 13 at least in sections.

In the shown exemplary embodiments, the stator 13 comprises at least one foam-like porous sound-damping element 23 in the region of the flow passage 15 leading away from the moving blades 12 of the rotor 11.

Alternatively or additionally it is also possible that the stator 13, in the region of the flow passage 14 leading towards the moving blades 12 of the rotor 11, comprises at least one such foam-like porous sound-damping element 23.

In the shown exemplary embodiments, the turbomachine 10 is embodied as radial compressor. It is also possible that the invention is employed with a radial turbomachine designed as radial turbine. In the case of a radial turbine, a flow passage leading towards the moving blades of the rotor extends in the radial direction and a flow passage leading away from the moving blades of the rotor, in the axial direction.

However, turbomachines combining a radial and an axial design are also possible as alternative.

The respective foam-like porous sound-damping element 23 produces a viscous sound-damping. Thus, sound can be more effectively dampened than with conventional resonator-type sound dampers. In particular, high-frequency vibration excitations of the rotor and of assemblies located downstream of the rotor can also be reduced. In addition, a reduced loss of pressure in the flow than with resonator-type sound dampers is incurred.

The invention also relates to a method for producing a turbomachine, while the rotor 11 and the stator 13 are provided for this purpose.

The rotor 11 can be a precision casting, chip-machined forging or chip-machined integrally produced component.

Furthermore, the stator 13 can be a precision casting at least in sections.

In the region of the or each foam-like, porous sound-damping element 23, the stator 13 is produced by way of a generative manufacturing method at least in sections.

In particular when the respective foam-like sound-damping element 23 is formed as a metal foam element, in particular an additive manufacturing method such as for example (selective) laser beam melting or electron beam welding can be utilised in particular. In this case, the metal foam is a sintered metal-like generated metal foam.

In particular when the diffuser 16 comprises at least one foam-like porous sound-damping element 23, a so-called diffuser ring of the diffuser 16, which at least provides a section of one of the walls 24 of the stator-side diffuser 16 and integrally also the guide blades 17 of the same is preferentially produced by way of a generative manufacturing method. In this case, the respective sound-damping element 23 is an integral part of the diffuser ring and thus of the diffuser 16. The diffuser ring provides the guide blades 17 of the diffuser 16 and at least in sections one of the walls 24, which delimit the flow passage 15 extending in the radial direction.

The specific section of the stator 13 comprising a foam-like sound-damping element 23, which is produced via a generative manufacturing method, is connected to an adjoining section of the stator 13 that is preferentially produced by precision casting and for this purpose inserted into a corresponding recess in the section of the stator 13 produced by precision casting.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A turbomachine, comprising:
a rotor having moving blades;
a stator having guide blades, which at least in sections delimit at least one first flow passage leading towards the moving blades of the rotor and at least one second flow passage leading away from the moving blades of the rotor; and
at least one foam-like porous sound-damping element configured as one of a foam element, a sinter-like foam element, and a plastic foam element and arranged in the stator in a region of at least one of the first and second flow passages.

13. The turbomachine according to claim 12, wherein a respective foam-like sound-damping element is produced by a generative manufacturing method.

14. The turbomachine according to claim 12, wherein a porosity of a respective foam-like sound-damping element is equally distributed such that a number of pores and a pore depth is locally identical.

15. The turbomachine according to claim 12, wherein a porosity of a respective foam-like sound-damping element in terms of a number of pores and/or a pore depth is not equally distributed but locally distinct.

16. The turbomachine according to claim 12, wherein a respective foam-like sound-damping element is part of a stator-side diffuser comprising the guide blades and/or an inlet-side flow region.

17. The turbomachine according to claim 16,
wherein the guide blades have a flow leading edge, a flow trailing edge, and flow control surfaces extending between the flow leading edge and the flow trailing edge,
wherein in a middle region between the flow leading edge and the flow trailing edge at least one of a larger number of pores, deeper pores, varying pore size, varying pore density, pore shape are formed than in regions adjoining the flow leading edge and the flow trailing edge.

18. The turbomachine according to claim 16,
wherein the guide blades have a flow leading edge, a flow trailing edge and flow control surfaces extending between the flow leading edge and the flow trailing edge,
wherein in a middle region between the flow control surfaces of adjacent guide blades a larger number of pores and/or deeper pores are formed than in regions adjoining the respective flow control surface.

19. The turbomachine according to claim 16, further comprising:
walls delimiting a respective flow passage and/or guide blades positioned in the respective flow passage and are at least in sections embodied as a foam-like porous element.

20. A method for producing a turbomachine comprising:
providing a rotor having moving blades;
providing a stator having guide blades, which at least in sections delimit at least one first flow passage leading towards the moving blades of the rotor and at least one second flow passage leading away from the moving blades of the rotor; and
producing the stator, at least in sections, in a region of a section comprising at least one foam-like porous sound-damping element, by way of a generative manufacturing method,
wherein the at least one foam-like porous sound-damping element is configured as one of a foam element, a sinter-like foam element, and a plastic foam element and is arranged in the stator in a region of at least one of the first and second flow passages.

21. The method according to claim 20, further comprising:
producing a first section of the stator by a forging worked by precision casting and/or chip machining and/or a chip-machined integrally produced component; and
producing at least one second section of the stator, which comprises at least one foam-like, porous sound-damping element via the a generative manufacturing method, and is inserted into a corresponding method in the first section.

22. The turbomachine according to claim 12, wherein the turbomachine is a radial compressor.
